(19) United States
(12) Patent Application Publication
(10) Pub. No.: US 2025/0307906 A1
(43) Pub. Date: Oct. 2, 2025

(54) METHOD AND SYSTEM FOR AUTOMATED COLOR MATCHING

(71) Applicant: SYNTES, INC., Bethesda, MD (US)

(72) Inventors: Anatoliy TISHIN, Bethesda, MD (US); Andrei LAVROV, Bethesda, MD (US); Vasiliy DOZHDALEV, Moscow (RU)

(21) Appl. No.: 19/090,565

(22) Filed: Mar. 26, 2025

Related U.S. Application Data
(60) Provisional application No. 63/570,452, filed on Mar. 27, 2024.

(51) Int. Cl. G06Q 30/0601; G01J 3/46; G06Q 10/087

(52) U.S. Cl. CPC G06Q 30/0641; G01J 3/463; G06Q 10/087

(57) ABSTRACT

Disclosed herein are a system and method for managing color matching for a project of a customer. In one aspect, the method comprises, defining a coloring project using a graph structure, receiving input user data for the coloring project, organizing elements of the coloring project using the graph structure, selecting a target color for each element or group of elements, for each element or group of elements, finding a respective paint that has a color matching the selected target color of the element or group of elements, after the selected paint is applied to the element or group of elements, comparing the paint applied to the element or group of elements with the respective target color, and making an adjustment to the selection when further optimization of the selection of the paint is needed based on the comparison.

### CROSS-REFERENCE TO RELATED APPLICATIONS

The present application claims priority to U.S. Provisional Patent Application No. 63/570,452, filed on Mar. 27, 2024, the entire contents of which are incorporated herein by reference.

### FIELD OF TECHNOLOGY

Aspects of the present disclosure relate to the field of color management for finding matching colors for projects, such as for painting walls, surfaces and commercial products (e.g., cars, garments), among other projects.

### BACKGROUND

An entity may need to provide a product that requires matching colors to existing objects or products, or matching colors in varying environments or backgrounds. For example, for the fashion industry, different items such as shirts, trousers, etc., may need to be dyed to look cohesive. However, based on the material, lighting, thickness, texture, whether or not the product has a liner, among other factors, application of the same dye may result in different resulting appearances in a real application.

In another example, painting a surface, e.g., a wall, that has been previously painted with a different shade of paint typically results in the actual result being somewhat different than expected. In addition, different types of surfaces and textures absorb the paint differently. Thus, a customer may be unhappy with a resulting product once the job is completed.

Therefore, there remains an unmet need for managing color matching for a project such that a customer is able to visualize how the color would appear after the project is completed.

### SUMMARY

Aspects of the disclosure relate to management of color matching, for example, for applying color on a surface, a product, in varying color environments or backgrounds, etc.

In one example aspect, a system for managing color matching for a project of a customer is provided. The system comprises: at least one memory; and at least one hardware processor coupled with the at least one memory and configured, individually or in combination, to: define a coloring project using a graph structure; receive, from a user, input user data for the coloring project; organize elements of the coloring project using the graph structure; select a target color for each element or group of elements of the coloring project; for each element or group of elements, find a respective paint that has a color matching the selected target color of the element or group of elements; after the selected paint is applied to the element or group of elements, compare the paint applied to the element or group of elements with the respective target color; and make an adjustment to the selection of the paint when further optimization of the selection of the paint is needed based on the comparison of the paint applied to the element or group of elements with the respective target color.

According to one example aspect of the disclosure, a method is provided for managing color matching for a project of a customer, the method comprising: defining a coloring project using a graph structure; receiving, from a user, input user data for the coloring project; organizing elements of the coloring project using the graph structure; selecting a target color for each element or group of elements of the coloring project; for each element or group of elements, finding a respective paint that has a color matching the selected target color of the element or group of elements; after the selected paint is applied to the element or group of elements, comparing the paint applied to the element or group of elements with the respective target color; and making an adjustment to the selection of the paint when further optimization of the selection of the paint is needed based on the comparison of the paint applied to the element or group of elements with the respective target color.

In one example aspect, the coloring project is managed via an automated management system, wherein the managing of the coloring project comprises, for each element or group of elements of the coloring project: determining the target color; applying a selected best match paint on the element or group of elements; executing control measurements on color samples of applied paint; analyzing a color difference between the color samples of the applied paint and the respective target color, and providing recommendation as to a need for a correction based results of the analysis; and correcting the selected best match paint when the recommendation indicates a need for the correction.

In one example aspect, the management of the coloring project further comprises, for each element or group of elements of the coloring project: providing to a user a selection of one or more potential matches from commercially available color systems using an advanced paint matching to a customer query algorithm via an application interface; and receiving a selection from the user, wherein the received selection comprises the selected best match paint.

In one example aspect, the paint that has a color matching the selected target color is automatically found by: storing a list of paint Stock Keeping Units (SKUs), which may be scannable bar codes often printed on product labels, in a database, wherein the list further includes information about each paint that has a paint SKU stored in the database; receiving a query from the user, wherein the query includes the target color; matching the target color to a paint color; searching in the database for at least one paint SKU associated with the matched paint color; selecting all paint SKUs associated with the matched paint color; determining availabilities of each of the selected paint SKUs; and creating a list of selected and available paint SKUs, and presenting the created list to the user for selecting, by the user, a preferred paint SKU form among paint SKUs on the list.

In one example aspect, the selecting of all paint SKUs associated with the matched paint color further comprises: querying for additional paint parameters in information associated with the coloring project; when the additional parameters are not described in the coloring project, receiving the additional paint parameters from the user in response to querying the user for the additional paint parameters; and selecting all paint SKUs associated with both the matched paint color and the additional paint parameters.

In one example aspect, the method further comprises: offering, to the user, options for ordering a selected paint online for a quantity needed for the painting project; when the offer is accepted by the user, placing an order for the selected paint, wherein a quantity of the paint needed for the coloring project is determined based on an area of a surface to be painted and a coverage of the paint having the selected paint SKU.

In one example aspect, the information about a paint that has a paint SKU stored in the database comprises one or more of: a unique identifier of the paint; a brand; a sub-brand or collection; manufacturer SKU corresponding to the paint SKU, if applicable; color coordinates; color name; color number; Light Reflectance Value (LRV); color collection; finish or sheen; a type of paint indicative of whether the paint is an exterior paint or an interior paint; chemistry of the paint indicative of whether the paint is latex type or acrylic; container of the paint; base of the paint; types of surfaces on which the paint can be used; coverage of the paint; drying time of the paint; recommended number of coats of the paint; Volatile Organic Compound (VOC) content of the paint; features of the paint; and price of the paint.

In one example aspect, the selection of the target color comprises: receiving the input user data from the user via an AI based chat application, the input data comprising at least one of: a textual description of a color of paint, color coordinates obtained using a colorimeter or a digital camera, or color coordinates of digital color data from a photograph; presenting to the user, via the AI based chat application, a selected patch representative of a paint matching the input user data; interacting with the user, via the AI based chat application, to adjust the selection of the patch when an adjustment is requested by the user; and when confirmation is received from the user indicating that the presented patch matches the input user data, selecting the paint represented by the patch as the target color.

In one example aspect, the method further comprises: interacting with the user via the AI based chat application and receiving a context for the coloring project; and generating names for colors that are obtained from the input user data based on the context of the coloring project.

In one example aspect, the input user data is obtained by at least one of the following: physically scanning colors using a colorimeter, or a spectrophotometer communicatively coupled to a device of the user; extracting colors from one or more digital images; entering color data in a standard format by the user; selecting color from a library of colors; and picking a color from among previously stored color data, for instance from the same or another project.

In one example aspect, for each element or group of elements, the finding of the respective paint that has a color matching the selected target color of the element or group of elements comprises: when a match between the target color and at least one paint color in a database is found, selecting the respective paint from among paints that meet a threshold criterion based on a distance between the target color and particular paints that meet the threshold criterion; when no match between the target color and at least one color in the database is found, determining whether a custom color can be created within the color library; when no match between the target color and at least one color in the color library is found and the custom color can be created within the color library, recommending a custom paint based on a respective color Gamut of a matched paint color; and when no match between the target color and at least one color in the color library is found and the custom color cannot be created within the color library, recommending an inspired paint color.

In one example aspect, the determination of whether the custom color can be created within a color library is based on color coordinates of the target color being within a color Gamut of at least one paint brand in the color library.

In one example aspect, the determination of whether the custom color can be created within the color library comprises: for each paint or paint brand of a coloring system, modeling color Gamuts of the color library to describe respective entire ranges of each color and tone achievable by the coloring system, wherein the modeling of the color Gamut is based on color measurements of commercially available color samples of a color system; mapping measured color coordinates of the measured color samples on a 3-dimensional color space; and creating a model of the color Gamut of the color system based on the color samples farthest from a center of the 3-dimensional color space.

In one example aspect, the graph structure is a tree structure that allows the user to: organize elements of a coloring project hierarchically; store color data and metadata in elements of the coloring project; assign custom names and naming systems to elements or groups of elements of the coloring project; navigate the structure using collapsible branches; evaluate projects by scrolling through the entire tree structure or by focusing on different branches of the tree structure; search for elements and groups of elements using search filters; group and regroup elements into branches according to current needs of the user for the coloring project; and assign status to elements or groups of elements, where the status includes at least one of: priority, current progress, assignment of a person responsible for a project or for an element.

In one example aspect, a non-transitory computer-readable medium is provided storing a set of instructions thereon for managing color matching for a project of a customer, wherein the set of instructions comprises instructions for: defining a coloring project using a graph structure; receiving, from a user, input user data for the coloring project; organizing elements of the coloring project using the graph structure; selecting a target color for each element or group of elements of the coloring project; for each element or group of elements, finding a respective paint that has a color matching the selected target color of the element or group of elements; after the selected paint is applied to the element or group of elements, comparing the paint applied to the element or group of elements with the respective target color; and making an adjustment to the selection of the paint when further optimization of the selection of the paint is needed based on the comparison of the paint applied to the element or group of elements with the respective target color.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates an example representative block diagram of a system for managing color matching, in accordance with aspects of the present disclosure.

FIG. 2a and FIG. 2b illustrate a flowchart of an example method for creating a color project, in accordance with aspects of the present disclosure.

FIG. 3a, FIG. 3b, and FIG. 3c illustrate a flowchart of an example method for inputting data about colors available from various sources into the system, in accordance with aspects of the present disclosure.

FIG. 4 illustrates a flowchart of an example method for creating and training an AI based LLM to be used for converting color to text and/or text to color, in accordance with aspects of the present disclosure.

FIG. 5 illustrates a flowchart of an example method for converting text to color, in accordance with aspects of the present disclosure.

FIG. 6 illustrates a flowchart of an example method for converting color to text, in accordance with aspects of the present disclosure.

FIG. 7a and FIG. 7b illustrate a flowchart of an example method for automatic selection of a paint SKU for a paint project, in accordance with aspects of the present disclosure.

FIG. 8 illustrates a flowchart of an example method for advanced paint matching to a query, in accordance with aspects of the present disclosure.

FIG. 9 illustrates a flowchart of an example method for modeling a color Gamut of a color library, in accordance with aspects of the present disclosure.

FIG. 10 illustrates a flowchart of an example method for providing recommendations based on advanced attributes of basic elements of a project, in accordance with aspects of the present disclosure.

FIG. 11 illustrates a flowchart of an example method for managing a color project, in accordance with aspects of the present disclosure.

FIG. 12 illustrates a flowchart of an example method for automatically managing a coloring project in accordance with aspects of the present disclosure.

FIG. 13 presents a representative diagram of an example of various components and features of a general purpose computer system usable or incorporable with various features in accordance with aspects of the present disclosure.

FIG. 14 is a block diagram of various example system components, usable in accordance with aspects of the present disclosure.

### DETAILED DESCRIPTION

Example aspects are described herein in the context of an apparatus, system, method, and various computer program features for managing color matching for a project, in accordance with aspects of the present disclosure. Those of ordinary skill in the art will realize that the following description is illustrative only and is not intended to be the only variant of the teachings in accordance with aspects of the present disclosure. Other aspects will readily suggest themselves to those skilled in the art having the benefit of the disclosure. Reference will now be made in detail to example implementations of various aspects as illustrated in the accompanying drawings. The same or similar reference indicators will be used to the extent possible throughout the drawings and the following description to refer to the same or like items. Accordingly, a detailed description of at least one preferred aspect of the disclosure is provided herein.

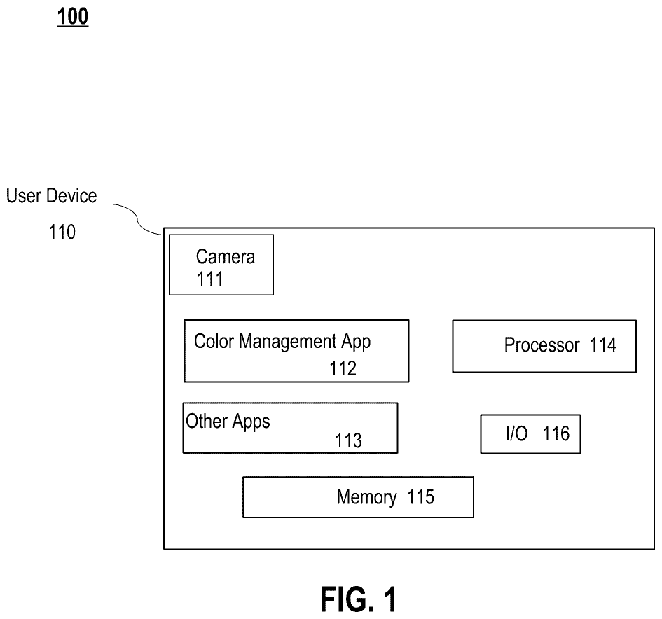

FIG. 1 illustrates an example representative block diagram of a system 100 for managing color matching, in accordance with aspects of the present disclosure. The system 100 shown in this example comprises a user device 110 that comprises a processor 114, memory 115 and I/O interface modules 116. For example, the user device 110 may be an iPad, iPhone, etc.

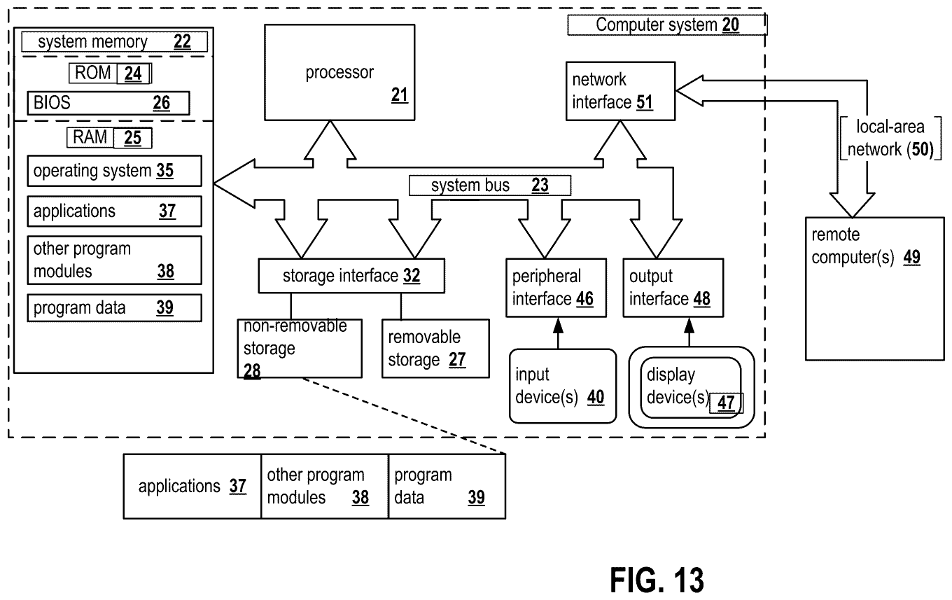

The user device 110 is configurable to define a project using a graph structure, organize elements of the project using the graph structure, select a target color for each element and/or for groups of elements, for each element and/or group of elements, find a paint/ink that has a color matching the selected target color, apply the selected paint/ink to the element and/or group of elements, and compare the paint/ink applied to the element and/or group of elements to the target color, optimize the selection of the paint/ink if an adjustment is needed. In one aspect, the user device is further described in conjunction with FIG. 13.

In one aspect, the graph structure comprises a hierarchical tree structure of objects for organizing a color project.

In one aspect, the project of the present disclosure involves working with colors and may involve any number of elements. For example, the project may involve working with color specification, color matching, color control, painting, coloring, etc. These types of projects typically involve many elements. For example, for a user who is an interior designer or a contractor, the project may involve painting buildings, roofs, walls, rooms, doors, etc. In another example, for a user who is a fashion designer, the project may involve producing items like shirts, trousers, which in turn, may have different parts like sleeves, legs, buttons, zippers etc.

Based on the type of project, the user of the present disclosure organizes the project using a hierarchical tree structure. For instance, suppose the project is for painting a building, then the project may be organized by defining a group for the building, a subgroup for each room, and elements for different parts of the room (e.g., walls, ceiling, floor and windows, among others). If the building is an apartment, the group may be the apartment number, a first subgroup may be defined for a first room, a second subgroup may be defined for a second room, etc. Then, for each room, a first element may be a first wall, a second may be a second wall, a third element may be the whole or parts of the ceiling, a fourth element may be the whole or parts of the floor, and so on.

In one aspect, the tree structure of the present disclosure allows the user to:
organize elements of a project hierarchically;
store color data and metadata (such as photos, notes, descriptions) in elements of the project;
assign custom names and naming systems to elements and/or groups of elements of the project;
navigate the structure using collapsible branches with ease;
evaluate projects at a glance by scrolling through the entire tree and/or by focusing on different branches of the tree;
search for elements and groups of elements using search filters, such as by searching for names, colors, metadata, status, and so on;
group and regroup elements into branches according to current needs, for example, by element, group, color, metadata, etc.; and
assign status to elements and/or groups of elements, where the status may include at least one of: priority, current progress, assignment of a person responsible for a project or an element, etc.

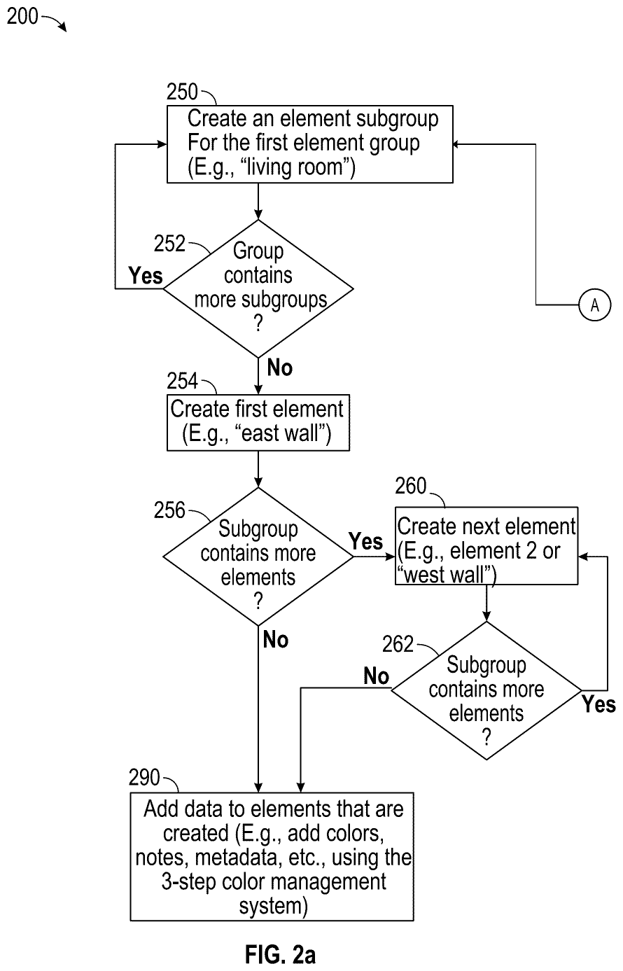

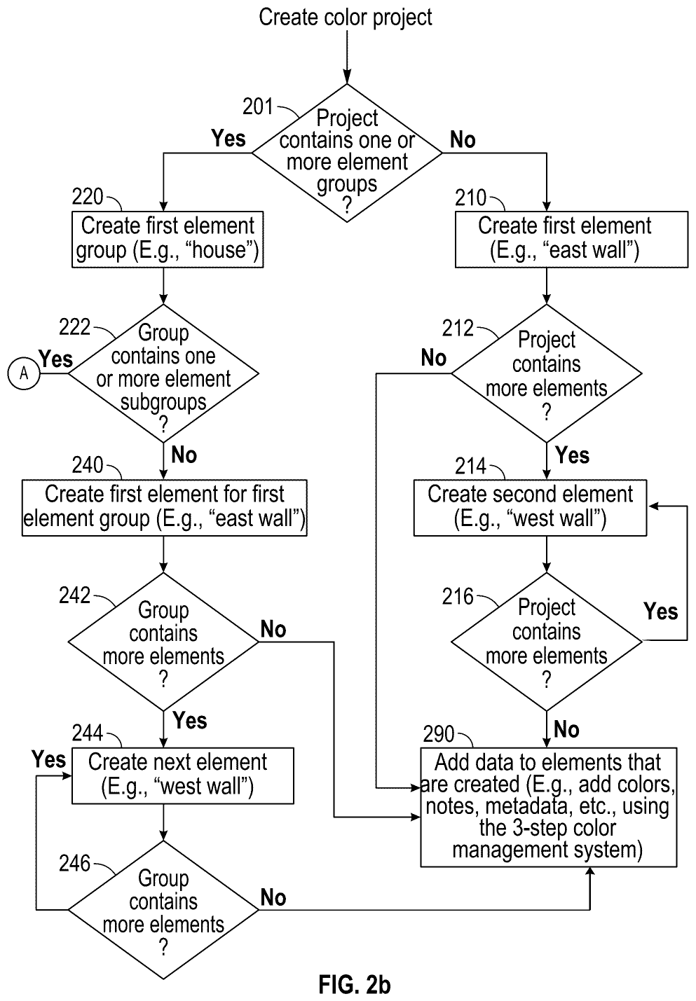

FIG. 2a and FIG. 2b illustrate a flowchart of an example method 200 for creating a color project, in accordance with aspects of the present disclosure.

In step 201, method 200 determines whether the project contains one or more element groups. When the project contains one or more element groups, method 200 proceeds to step 220. Otherwise, method 200 proceeds to step 210.

In step 210, method 200 creates a first element. The method proceeds to step 212.

In step 212, method 200 determines whether the project contains more elements. In other words, the method determines whether there are more elements besides the first element created in step 210. When the project contains more elements, method 200 proceeds to step 214. Otherwise, method 200 proceeds to step 290.

In step 214, method 200 creates a second element for the first element group. The method then proceeds to step 216.

In step 216, method 200 determines whether the project contains more elements. When the project contains at least one more element that has not been created, the method proceeds to step 214. Otherwise, the method proceeds to step 290. Thus, the method returns to step 214 until all elements are created for the first element group. When all elements are created for the first element group, the method proceeds to step 290.

In step 220, method 200 creates a first element group and proceeds to step 222.

In step 222, method 200 determines whether the first element group contains more than one subgroup. When the first element group contains more than one subgroup, method 200 proceeds to step 250. Otherwise, method 200 proceeds to step 240.

In step 240, method 200 creates a first element for the first element group created in step 220. Then, method 200 proceeds to step 242.

In step 242, method 200 determines whether the first element group created in step 220 contains more elements that are not yet created. When the first element group created in step 220 contains more elements that are not yet created, method 200 proceeds to step 244. Otherwise, method 200 proceeds to step 290.

In step 244, method 200 creates a second element for the first element group created in step 220. Then, the method proceeds to step 246.

In step 246, method 200 determines whether the first element group created in step 220 contains more elements that are not yet created. When the first element group created in step 220 contains more elements that are not yet created, method 200 proceeds to step 244. Otherwise, method 200 proceeds to step 290.

In step 250, method 200 creates an element subgroup for the first element group. The method then proceeds to step 252.

In step 252, method 200 determines whether the first element group contains more subgroups that are not yet created. When the first element group contains more subgroups that are not yet created, method 200 proceeds to step 250. Otherwise, method 200 proceeds to step 254.

In step 254, method 200 creates a first element for the first element group. Then, method 200 proceeds to step 256.

In step 256, method 200 determines whether or not the first subgroup contains more elements. When the first subgroup contains more elements, method 200 proceeds to step 260. Otherwise, method 200 proceeds to step 290.

In step 260, method 200 creates a second element for the first element group. Then, method 200 proceeds to step 262.

In step 262, method 200 determines whether the subgroup contains more elements. When the subgroup contains more elements that are not creates, method 200 proceeds to step 260. Otherwise, method 200 proceeds to step 290.

Then, steps 254-262 are performed for each subgroup by iterating through each subgroup.

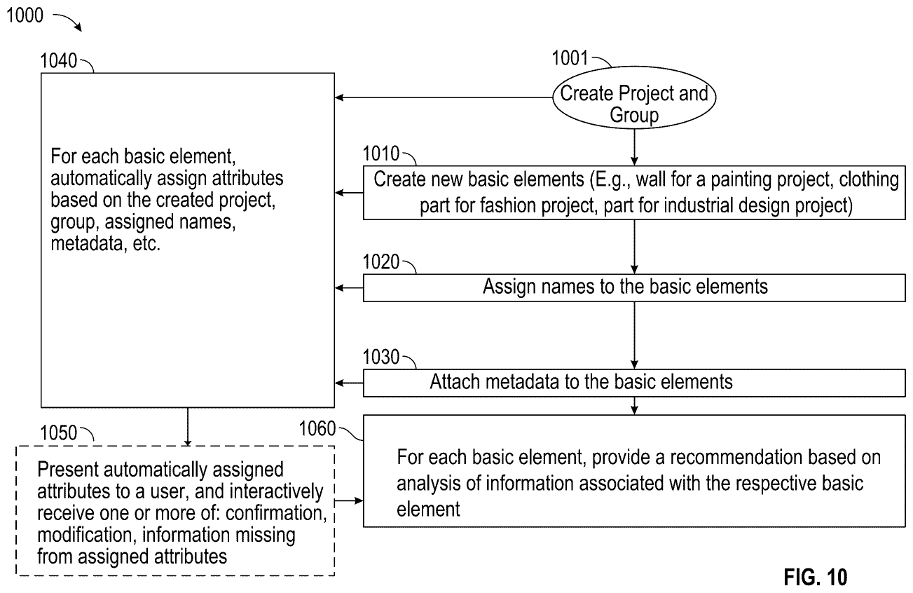

In step 290, method 200 adds data to elements that are created. In one aspect, the added data comprises: colors, metadata, descriptions, etc. using, for example, as shown in FIG. 10.

After the elements of the project are organized and/or grouped using the hierarchical tree structure, a target color is selected for each element and/or for groups of elements. In one aspect, the target color is selected by the user from a library. In another aspect, the target color is obtaining by making measurements of a sample.

In one aspect, the measurement of the target color is made using a color spectrophotometer which is a device used to measure color. In another aspect, the measurement of the target color is made using a camera, such as a camera of a mobile device.

Once the target color is selected, in one aspect, the process proceeds to finding a paint or ink that matches the selected target color. In one aspect, the paint/ink that matches the selected target color is determined by choosing from a library of paints/inks. In one aspect, the library of paints/inks contains products from any number of vendors. The determination of the matching paints/inks may be based on a threshold parameter that quantifies a color distance between the target color and particular paints/inks. Thus, within the predetermined threshold value any number of paints/inks may match the target color.

In one aspect, the measurement of the color distance between the target color and a particular paint/ink is made using at least one of: a color spectrophotometer or a camera (e.g., of a mobile device).

In one aspect, for the given element or group of elements, a paint/ink is selected from among the paints/inks that meet the threshold criteria based on the distance between the target color and the particular paints/inks. In one aspect, the criteria for selection of the paint/ink may further be based on priority, preference of a particular vendor product, cost, and any other factors relevant to the user.

In one aspect, the paint/ink is selected automatically by matching identifiers of paint/ink such as, a scannable bar code of the paint/ink. The scannable bar code may be known as a Stock Keeping Unit (SKU) often printed on product labels.

In one aspect, the automatic selection of the paint/ink may be performed via a software application installed on a user device. In one aspect, the application includes at least one interface for receiving: input user data, and input from one or more online databases of paint/ink SKUs.

In one aspect, the at least one interface for receiving the input user data receives the color data obtained by at least one of the following:
physically scanning colors using a colorimeter, or a spectrophotometer communicatively coupled to a device of the user (e.g., a mobile device of the user) via a Bluetooth connection, a physical connection such as via a USB port or any other standard interface for exchanging data;
extracting colors from one or more digital images, wherein the extraction of a color may be performed by enabling the user to select a physical location on a given image;
entering color data in a standard format by the user;
selecting color from a library of colors, paints/inks provided by various vendors; and
picking a color from among previously stored color data, for instance from the same or another project.

In one aspect, the one or more digital images from which a color is extracted may be an image stored in a photo library of the user device, an image taken by a camera of the user device. In one aspect, the selection of the physical location on the given image for extracting of the color is performed via a “Color Picker” which is a tool that enables the user to point to a particular place on the image. In one aspect, the Color Picker comprises a magnifying feature for enabling the user to pick the color with ease.

In one aspect, when the user manually enters color data, the color data is in one of the following formats: (Red-Green-Blue (RGB), Cyan, Magenta, Yellow and Key (CMYK), Hue Saturation Lightness (HSL), and C-Lab (with C representing Color, L representing darkness to lightness, with values ranging from 0 to 100, a representing greenness to redness with values of −128 to +127, and b representing blueness to yellowness with values from −128 to +127). Regardless of the format of the color data when received from the user, the received color data is uniformly formatted and is usable in color quality control as a target color, standard color, or test color data.

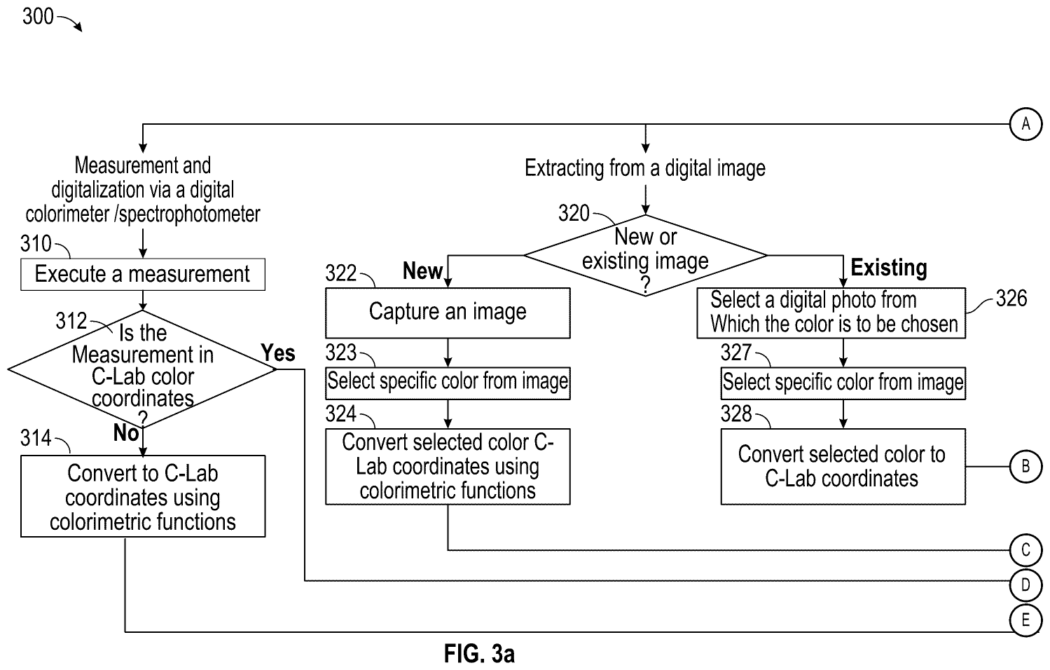

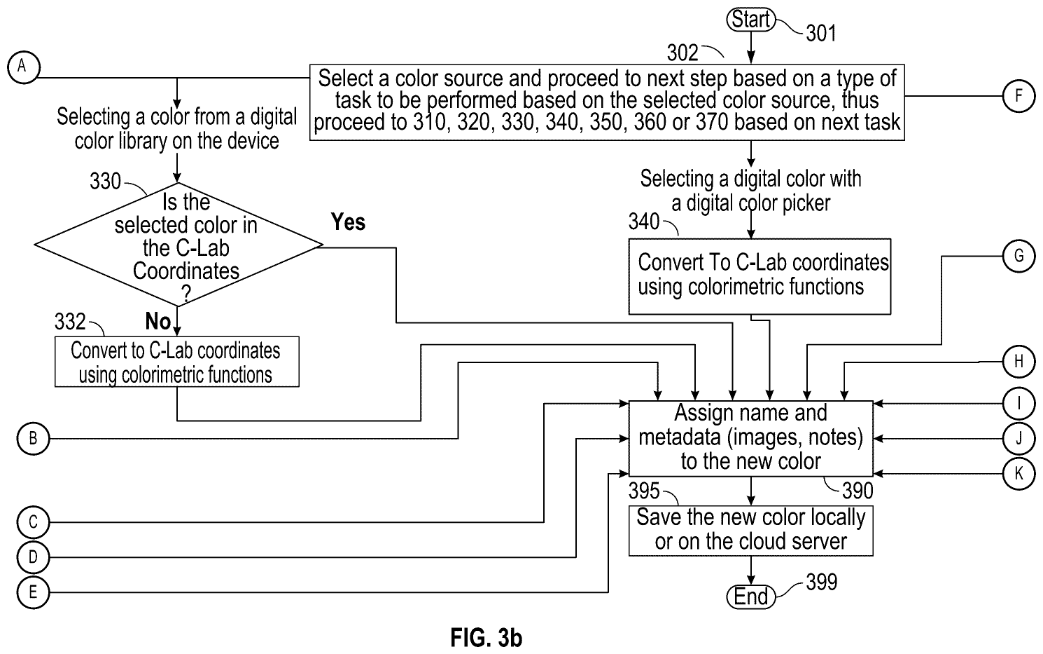

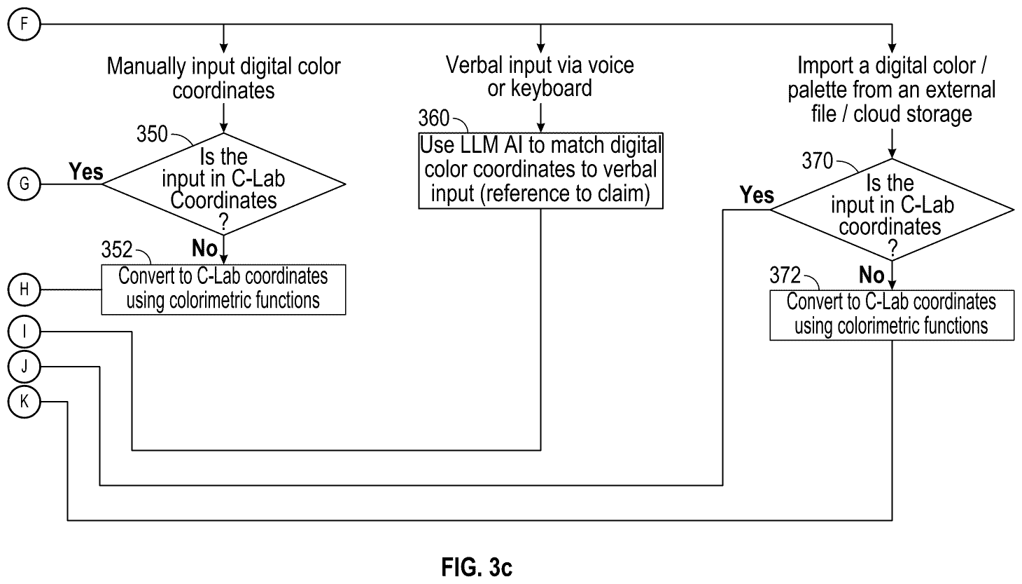

As described above, the software application for automatic selection of the paint/ink includes at least one interface for receiving: input user data, and input from one or more online databases of paint/ink SKUs. In order to support the functions of this software application, data with regard to paint colors available from various sources is first input into the digital system. FIG. 3a, FIG. 3b, and FIG. 3c illustrate a flowchart of an example method 300 for inputting data about colors available from various sources into the system, in accordance with aspects of the present disclosure. Method 300 starts in step 301 and proceeds to step 302.

In step 302, method 300 selects a color source. When the selected color source is used for obtaining a color by physically scanning colors using a colorimeter or a spectrophotometer, method 300 proceeds to step 310. When the selected color source is used for extracting a color from a digital image, method 300 proceeds to step 320. When the selected color source is used for selecting a color from a digital color library on the user device, method 300 proceeds to step 330. When the selected color source is used for selecting a digital color with a digital color picker, method 300 proceeds to step 340. When the selected color source is used for manually inputting digital color coordinates, method 300 proceeds to step 350. When the selected color source is used for input via voice or keyboard, method 300 proceeds to step 360. When the selected color source is importing a digital color or palette from an external file or cloud storage, method 300 proceeds to step 370.

In step 310, method 300 executes a measurement.

In step 312, method 300 determines whether the measurement provides input data in a C-Lab color coordinate format. When the measurement executed in step 310 provides the input data in a C-Lab color coordinate format, method 300 proceeds to step 390. Otherwise, the method proceeds to step 314.

In step 314, method 300 converts the input data to the C-Lab color coordinate format. Then, method 300 proceeds to step 390.

In step 320, method 300 determines whether or not the extraction of the digital image is performed from a new or an existing image. When the extraction is from a new image, method 300 proceeds to step 322. Otherwise, method 300 proceeds to step 326.

In step 322, method 300 captures an image with a digital camera of the user device or a camera communicatively coupled to the user device.

In step 323, method 300 selects a specific color from the image captured in step 322.

In step 324, method 300 converts the input data to the C-Lab color coordinate format. Then, method 300 proceeds to step 390.

In step 326, method 300 selects an existing digital photo from which the color is to be selected. The selected existing digital photo may be from an image gallery on the device of the user or from another source, such as from the internet.

In step 327, method 300 selects a specific color from the existing image selected in step 326.

In step 328, method 300 converts the selected color to the C-Lab color coordinate format. For example, the selected color may be converted from an RGB format to the C-Lab format. Then, method 300 proceeds to step 390.

In step 330, method 300 determines whether the color selected from the digital color library on the user device is in a C-Lab color coordinate format. When the color selected from the digital color library in step 310 is in the C-Lab color coordinate format, method 300 proceeds to step 390. Otherwise, the method proceeds to step 332.

In step 332, method 300 converts the color selected from the digital color library to the C-Lab color coordinate format. For example, the conversion may be performed using a colorimetric function. Then, method 300 proceeds to step 390.

In step 340, method 300 converts the digital color selected with the digital color picker to the C-Lab color coordinate format. For example, the conversion may be performed from RGB format to the C-Lab color coordinate format. Then, method 300 proceeds to step 390.

In step 350, method 300 determines whether or not the manually inputted digital color coordinates are in the C-Lab color coordinate format. When the manually inputted digital color coordinates are in the C-Lab format, method 300 proceeds to step 390. Otherwise, the method proceeds to step 352.

In step 352, method 300 converts the manually inputted digital color coordinates to the C-Lab color coordinate format. For example, the conversion may be performed using a colorimetric function. Then, method 300 proceeds to step 390.

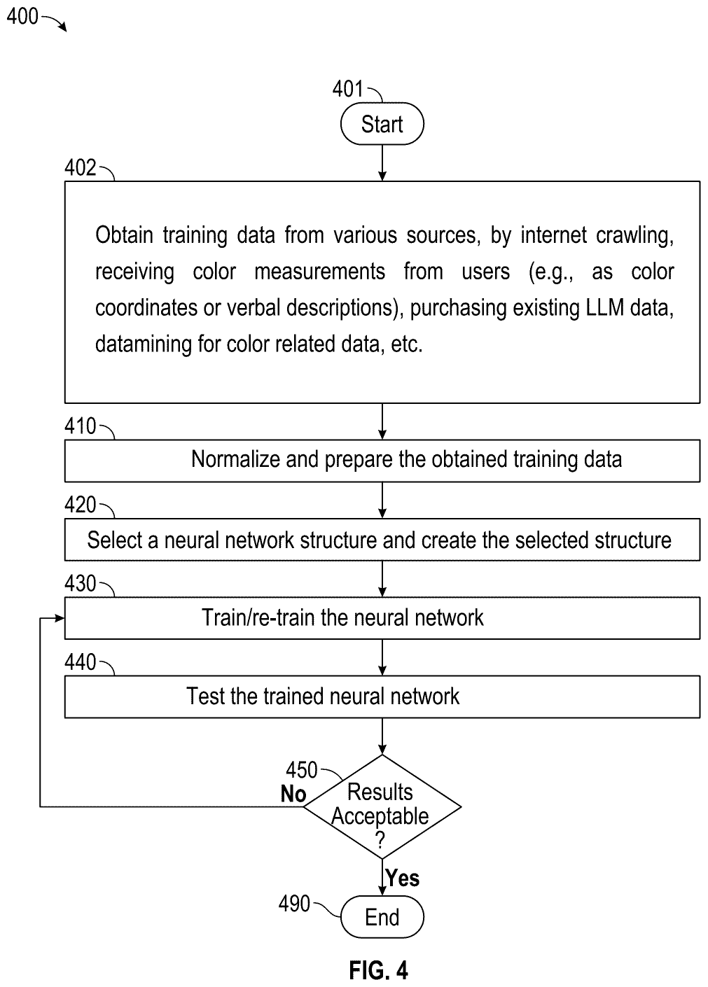

In step 360, method 300 uses an AI based Large Language Model (LLM) to match digital image coordinates to the verbal input. The method then proceeds to step 390. The AI based LLM for converting color to text and/or text to color is created as described below in conjunction with FIG. 4.

In step 370, method 300 determines whether or not the digital color or palette imported from an external file or cloud storage is in the C-Lab color coordinate format. When the digital color or palette imported from an external file or cloud storage is in the C-Lab format, method 300 proceeds to step 390. Otherwise, the method proceeds to step 372.

In step 372, method 300 converts the digital color or palette imported from the external file or cloud storage to the C-Lab color coordinate format. For example, the conversion may be performed using a colorimetric function. Then, method 300 proceeds to step 390.

In step 390, method 300 assigns names and metadata to new colors.

In step 395, method 300 stores new colors on a cloud server and/or on a local server.

In step 399, method 300 ends the inputting of data about colors available from various sources into the system.

FIG. 4 illustrates a flowchart of an example method 400 for creating and training an AI based LLM to be used for converting color to text and/or text to color, in accordance with aspects of the present disclosure. Method 400 starts in step 401 and proceeds to step 402.

In step 402, method 400 obtains training data from various sources. In one aspect, the training data may be obtained by one or more of: internet crawling, receiving color measurements from users (e.g., as color coordinates or verbal descriptions), purchasing existing LLM data, datamining for color related data, etc.

In step 410, method 400 normalizes and prepares the obtained training data.

In step 420, method 400 selects a neural network structure and creates the selected neural network.

In step 430, method 400 trains/retrains the neural network.

In step 440, method 400 tests the trained neural network.

In step 450, method 400 determines whether results of the test show that the trained neural network is acceptable. When the trained neural network is acceptable, method 400 proceeds to step 490. Otherwise, the method proceeds to step 430 to retrain the neural network.

In step 490, method 400 terminates the training of the neural network.

Once the AI based LLM is trained, it may be used for converting text to color or color to text, as needed.

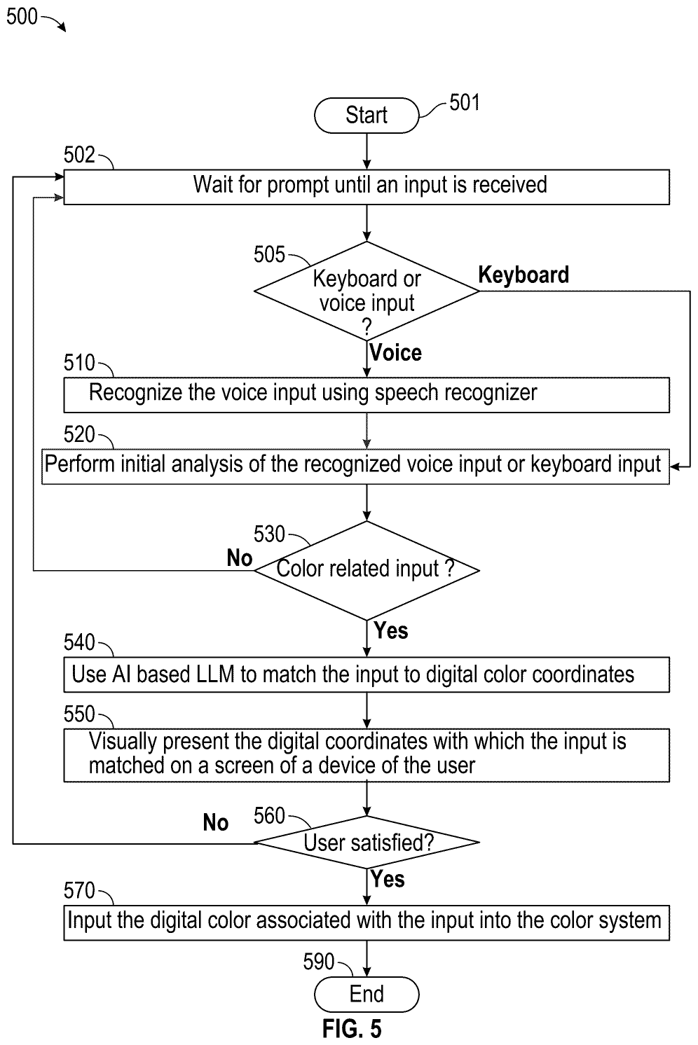

FIG. 5 illustrates a flowchart of an example method 500 for converting text to color, in accordance with aspects of the present disclosure. Method 500 starts in step 501 and proceeds to step 502.

In step 502, method 500 waits for a prompt from a user.

In step 505, method 500 receives an input either as voice input or a keyboard input. When the received input is a voice input, method 500 proceeds to step 510. When the received input is a keyboard input, method 500 proceeds to step 520.

In step 510, method 500 recognizes the voice input using a speech recognizer, e.g., a commercially available speech recognizer.

In step 520, method 500 performs an initial analysis of the recognized voice input or the keyboard input.

In step 530, method 500 determines whether the recognized voice input or keyboard input is a color related input. When the input is color related, method 500 proceeds to step 540. Otherwise, the method returns to step 502 to wait for a next prompt.

In step 540, method 500 uses an AI based LLM to match the input to digital color coordinates.

In step 550, method 500 visually presents the digital coordinates with which the input is matched on a screen of the device of the user.

In step 560, method 500 determines whether the user is satisfied with the presented digital coordinates. When the user is satisfied, the method proceeds to step 570. Otherwise, the method proceeds to step 502.

In step 570, method 500 inputs the digital color associated with the input into the color system. For example, the digital color of the presented digital coordinates may be for a new digital color.

In step 590, method 500 terminates the conversion of text to color.

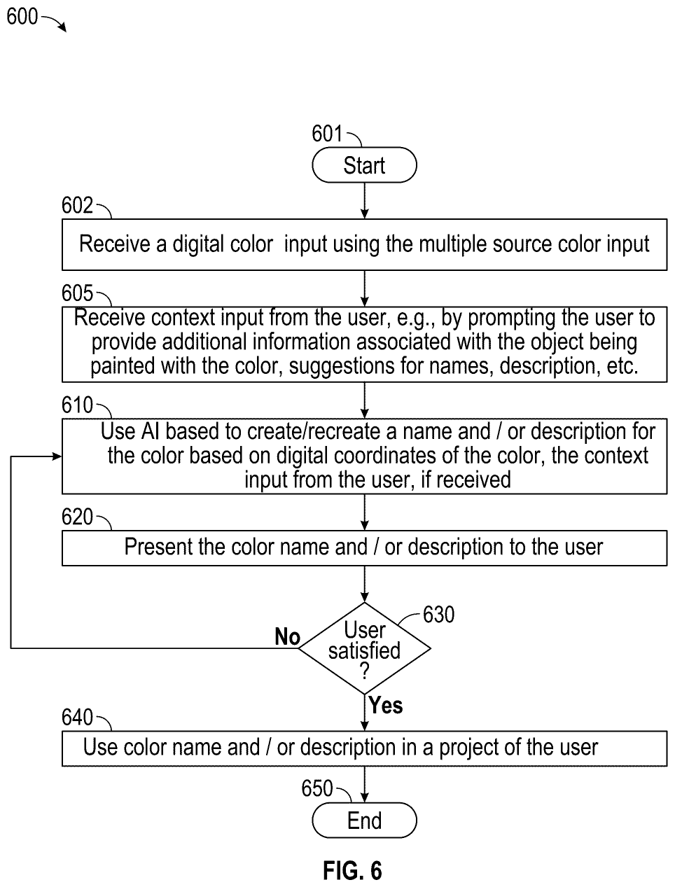

FIG. 6 illustrates a flowchart of an example method 600 for converting color to text, in accordance with aspects of the present disclosure. Method 600 starts in step 601 and proceeds to step 602.

In step 602, method 600 receives a digital color input. The digital color input may be received from various types of sources, for instance, as described in FIG. 3a, FIG. 3b and FIG. 3c.

In optional step 605, method 600 receives context input from the user. The context input may be received by prompting the user to provide additional information, such as what feelings are associated with the object being painted with the color, suggestions for names, description, and the like.

In step 610, method 600 uses an AI based LLM to create/recreate a name and a description for the color based on digital color coordinates of the color, and the context input from the user, if such context input is received.

In step 620, method 600 presents the color name and description to the user on a screen of the device of the user.

In step 630, method 600 determines whether the user is satisfied with the presented name and description. When the user is satisfied, the method proceeds to step 640. Otherwise, the method proceeds to step 610.

In step 640, method 600 uses the color name and description in a project of the user.

In step 690, method 600 terminates the conversion of color to text.

In one aspect, the input user data comprises at least one of: the target color, desired sheen, characteristic of paints that might be used for selecting a specific paint/ink that matches the user's need, object/element to be painted, an area to be painted that such an amount of paint/ink can be determined, brand preference, the user's budget, etc. In one aspect, the characteristic of paints/inks include at least specifications for Volatile Organic Compounds (VOC), such as zero VOC, low VOC, and the like.

In one aspect, the input user data is received via an AI based chat application based on textual description of the paint/ink by the user. For example, the user may ask for a color by name and the AI chat application may provide a response in a form of a color patch with color coordinates. Then, the user may interact with the application and adjust the result to provide further input thereby enabling optimization. For instance, suppose the user provides a description of the paint as “sea water in the middle of a sunny day.” Then, the AI based chat application may present a patch to the user. The user may then further specify by requesting a lighter shade, a darker shade, more or less translucent, more or less sheen, and the like. Thus, the selection of the paint may be performed via an interaction of the user with AI based chat application to provide input to the automated system.

In one aspect, the input user data may further include color coordinates obtained using a colorimeter or a digital camera. In one aspect, the input user data may further include color coordinates or imported digital color data from a photograph.

In one aspect, the AI based chat application may generate names for the colors that are obtained from the input user data by interacting with the user via the AI based chat application and receiving the context for the room, as described above in conjunction with FIG. 6. For example, the user may provide a context such as, the color being for a children's room, the color being for a sport's car, the color being for an evening dress, and so on. The context may then be used to generate an appropriate name for the color.

In one aspect, the brand preference may be received from the user. In another aspect, the brand preference may be based on a recommendation provided to the user by the application from among brands that are locally available to the user. For example, the online database of paint/ink SKU may include specifications of broad selection of commercially available paint/ink SKUs and their respective availabilities in stores near the user's physical location.

In one aspect, the recommendation is provided to the user by the application in response to the user inputting a query. Then, upon receiving the query, the application selects SKUs of a number of paints/inks and primers (if applicable), and presents the selected SKUs of the paints/inks and/or primers to the user. In one aspect, the selected SKUs of the paints/inks and/or primers may be sorted in accordance with the preference of the user based on at least one of: brand, specific paint/ink features, price, rating, popularity, availability, and so on.

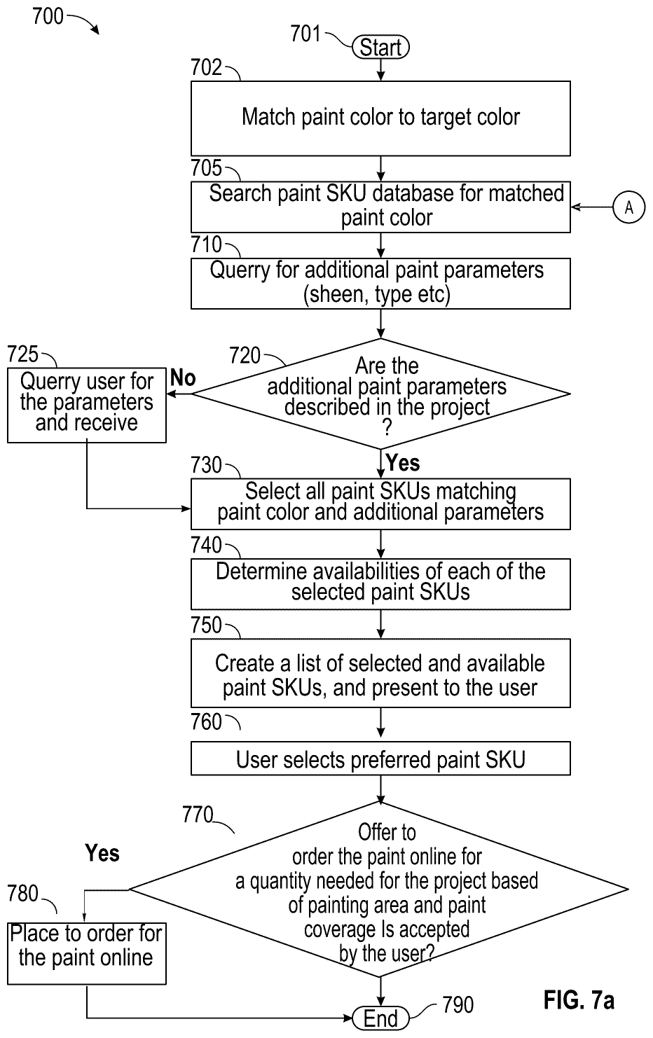

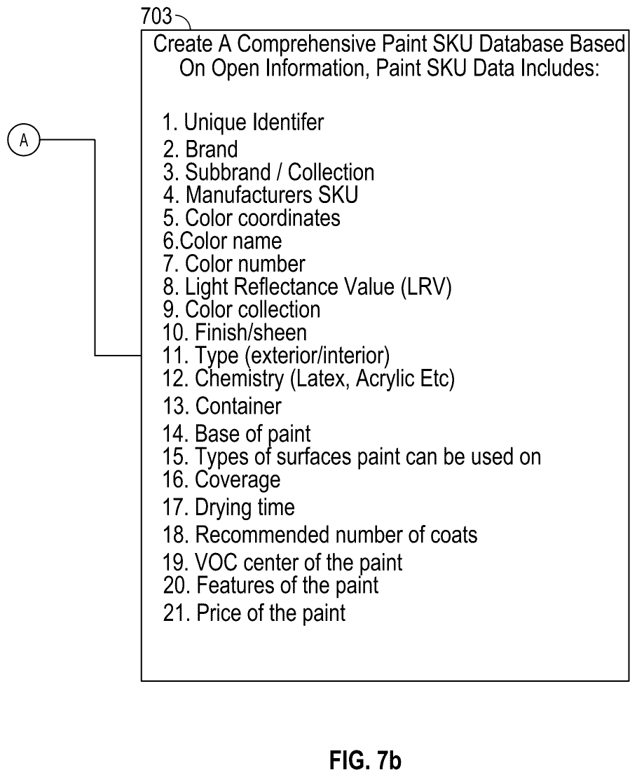

FIG. 7a and FIG. 7b illustrate a flowchart of an example method 700 for automatic selection of a paint SKU for a paint project, in accordance with aspects of the present disclosure. Method 700 starts in step 701 and proceeds to step 702.

In step 702, method 700 matches a target color to a paint color. Then, method 700 proceeds to step 705.

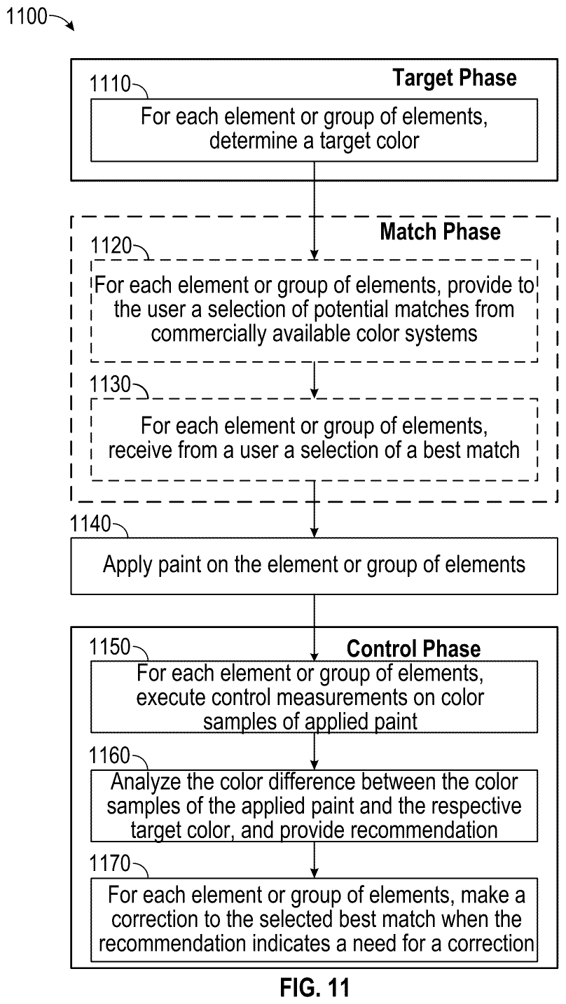

The matching of the target color to the paint color is further described in conjunction with FIG. 11, which illustrates a flowchart of an example method for managing a color project, in accordance with aspects of the present disclosure.

In one aspect, in order to facilitate the matching of the target color to the paint color, a database 703 is created for storing a comprehensive list of paint SKUs.

In one aspect, for each paint, the data stored in the database 703 includes one or more of:
a unique identifier of the paint;
a brand;
a sub-brand or collection;
manufacturers SKU corresponding to the paint SKU, if applicable;
color coordinates;
color name;
color number;
Light Reflectance Value (LRV);
color collection;
finish/sheen;
a type of paint indicative of whether the paint is an exterior paint or an interior paint;
chemistry of the paint indicative of whether the paint is latex type, acrylic, etc.;
container of the paint;
base of the paint;
types of surfaces on which the paint can be used;
coverage of the paint;
drying time of the paint;
recommended number of coats of the paint;
VOC content of the paint;
features of the paint; and
price of the paint.

In step 705, method 700 searches in the database 703 for the paint SKU associated with the matched paint color.

In step 710, method 700 queries for additional paint parameters in information associated with the project. For example, the query may be for determining sheen, type, etc., needed for the project.

In step 720, method 700 determines whether or not the additional paint parameters are described in the project. When the additional paint parameters are described in the project, method 700 proceeds to step 730. Otherwise, method 700 proceeds to step 725.

In step 725, method 700 queries the user for the additional paint parameters and receives the additional paint parameters, when applicable. Then, method 700 proceeds to step 730. In step 730, method 700 selects all paint SKUs matching paint color and additional paint parameters.

In step 740, method 700 determines availabilities of each of the selected paint SKUs. For example, the availability may be determined by searching online.

In step 750, method 700 creates a list of selected and available paint SKUs, and presents the list to the user. In one aspect, the list of selected and available paint SKUs is presented along with price and selling location for each paint SKU.

In step 760, by the user, method 700 selects a preferred paint SKU form the list.

In step 770, method 700 determines whether an offer to order the selected paint online for a quantity needed for the project is accepted by the user. When the offer is accepted, method 700 proceeds to step 780. Otherwise, method 700 proceeds to step 790. In one aspect, the quantity of paint needed for the project is determined based on an area of the surface to be painted and the coverage of the selected paint.

In step 780, method 700 places an order for the selected paint. The method then proceeds to step 790.

In step 790, method 700 terminates the conversion of color to text.

As described above, for the given element or group of elements, a paint/ink is selected from among the paints/inks that meet the threshold criteria based on the distance between the target color and the particular paints/inks. However, when attempting to match a target color to colors stored in a library, a match to a particular color in the library may not be found.

When no match between the target color and a color in the library is not found, in one aspect, a custom color may be created within the color library. In another aspect, neither a match between the target color and a color in the library nor a match between the target color and a custom color that can be created within the color library is found. Thus, there are three possible outcomes when attempting to match the target color to a color in the library:
an acceptable match is found between the target color and at least one color in the color library;
an acceptable match is not found but a custom color can be created within the color library; and
an acceptable match with a color currently in the library is not found and no custom color can be created within the color library.

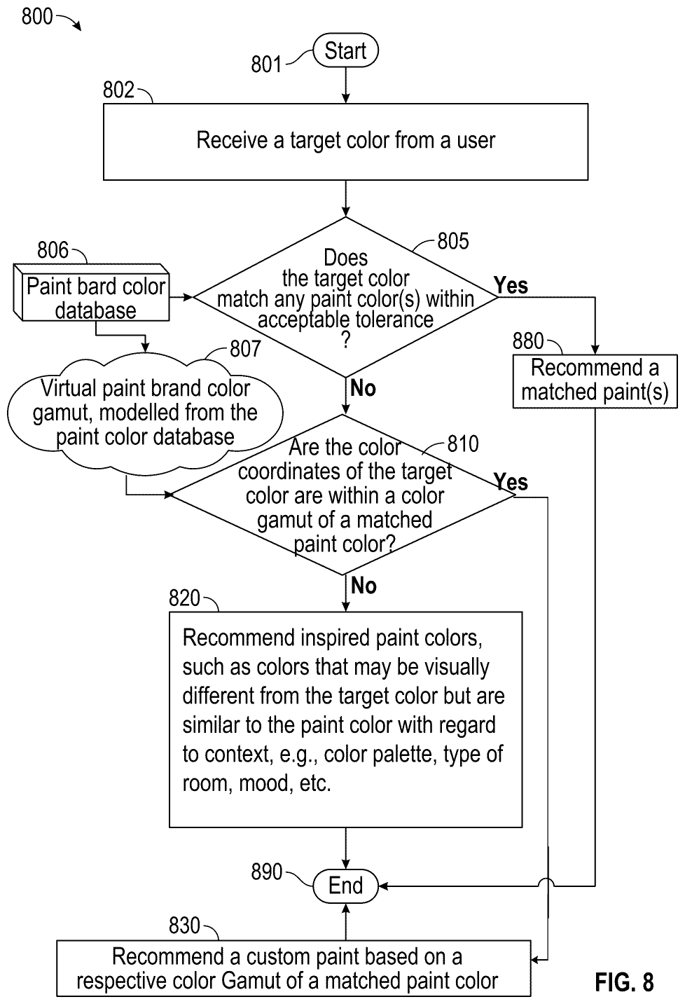

FIG. 8 illustrates a flowchart of an example method 800 for advanced paint matching to a query, in accordance with aspects of the present disclosure. Method 800 starts in step 801 and proceeds to step 802.

In step 802, method 800 receives a target color from a user. The target color may be received from various types of sources, for instance, as described in FIG. 3a, FIG. 3b, and FIG. 3c.

In step 805, method 800 determines whether the received target color matches one or more paint colors in a database, e.g., the database of paint brand colors 806, with a difference between the target color and a respective paint color of the one or more paint colors being less than a predetermined threshold. When a match between the target color and at least one paint color in the database is found, method 800 proceeds to step 880. Otherwise, the method proceeds to step 810.

In step 810, method 800 determines whether or not color coordinates of the target color are within a color Gamut of the matched one or more paint colors. In order to facilitate the comparison of the target color with paint brand color Gamuts, in one aspect, for each color brand, a respective color Gamut is stored in the database 806. Then, a virtual model 807 of paint brand color Gamuts is maintained based on modeling of the paint colors in the database 806. When color coordinates of the target color are not within a color Gamut of a paint brand, method 800 proceeds to step 820. When color coordinates of the target color are within a color Gamut of a paint brand, method 800 proceeds to step 830.

In step 820, method 800 recommends inspired paint color, such as color that may be visually different from the target color but are similar to the paint color with regard to context, e.g., color palette, type of room, mood, being in nature, being in a city setting, etc. The method then proceeds to step 890.

In one aspect, the recommendation of the inspired paint color further includes: providing options for one or more of: prioritizing hue, lightness, and chroma.

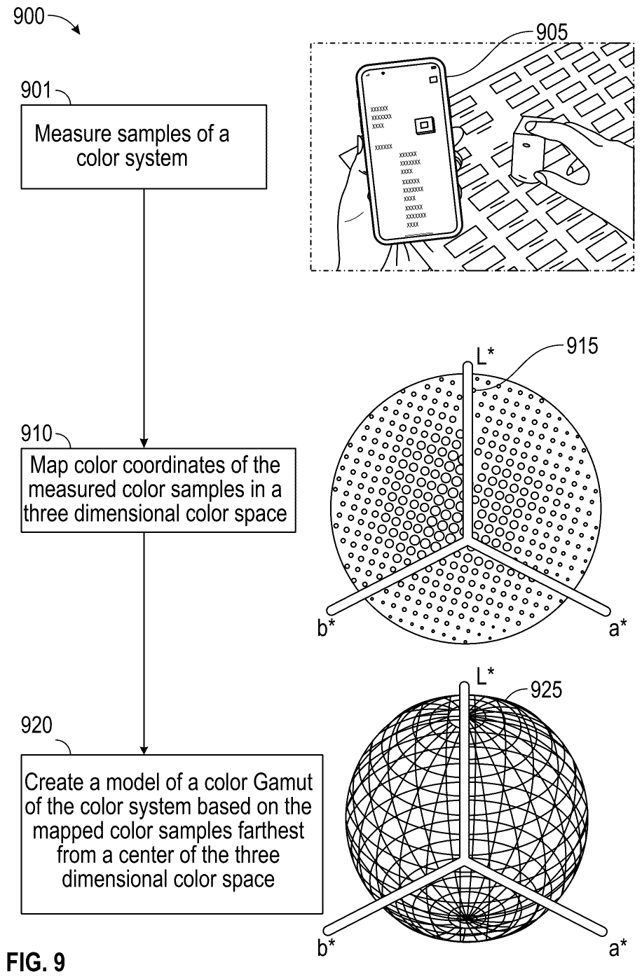

In step 830, method 800 recommends a custom paint based on a respective color Gamut of a matched paint color. The modeling of the Color Gamut of the color library for determining whether or not the custom color can be created is further described below in conjunction with FIG. 9.

In step 880, method 800 recommends at least one matched paint of the one or more paint colors to the user.

In step 890, method 800 terminates the method of paint matching.

In one aspect, whether or not a custom color can be created within the color library of a color system is determined based on modeling of the Color Gamut of the color library that describes the entire range of colors and tones achievable by the color system. In one aspect, the modeling of the Color Gamut of the color library is performed based on color measurements of commercially available color samples. In one aspect, the modeling of the Color Gamut of the color library comprises: measuring commercially available color samples of a color system; mapping measured color coordinates of the measured color samples on a 3-dimensional color space; and creating a model of the color Gamut of the color system based on the color samples farthest from a center of the 3-dimensional color space.

FIG. 9 illustrates a flowchart of an example method 900 for modeling a color Gamut of a color library, in accordance with aspects of the present disclosure.

In step 901, method 900 measures color samples of a color system. The color samples may be for a commercially available product. In one aspect, the measuring of the color samples may be performed via the device of the user, such as a mobile phone 905.

In step 910, method 900 maps color coordinates of the measured color samples in a 3-dimensional color space, such as the C-Lab color space 915.

In step 920, method 900 creates a model the color Gamut of the color system based on the mapped color samples farthest from a center of the 3-dimensional color space, as shown in 925.

Returning to the organization of elements of a project and the selection of the target color, as mentioned above, the target color is selected for each element and/or for groups of elements. Thus, for a given color project, the most basic elements are singular elements to be painted/colored. In one aspect, the present disclosure describes providing recommendations to a user based on advanced attributes of the basic elements of the project.

In one aspect, the recommendations are for at least one of the following:
preparation of a surface/element for applying the paint;
ways of performing the paining/coloring job; and
recommendations related to maintenance of the painted/colored surface, etc.

In one aspect, in order to determine the advanced attributes of the basic elements, the user is prompted to assign a name to the basic element and to add metadata to be associated with the basic elements. For example, the metadata may include photos and notes related to the basic element.

In one aspect, an AI-powered application may:
analyze all available information about the basic element, including project name, project parameters, group name, parameters of the group to which the element belongs, name of the element, metadata of the element, data gathered from devices (e.g., sensors for temperature, moisture, and the like); and
determine the advanced attributes of the element based on the analysis.

For example, for a painting project, the attributes may include one or more of:
class (for instance, wall, celling, floor, door, etc.);
type of surface (for instance, drywall, plaster, wood, steel, brick, etc.);
special features of surface (for instance, bare surface, previously painted surface with a description of the coat of the previous paint (e.g., being intact, flacking, having remnants, dirty, clean, etc.); and
environment at location of the element (e.g., temperature, moisture, direct sunlight, no sunlight, average hours of sunlight, etc.).

In one aspect, the AI-powered application interacts with the user to ask the user for missing attributes and requests, from the user, confirmation of the determined attributes.

Once the attributes are determined, the recommendation is provided to the user based on the attributes. In one aspect, the recommendation includes a recommendation for one or more of: surface preparation, paint characteristics (e.g., sheen, VOC content, resistance, odor, washability, etc.), exact paint SKU, painting techniques, cleanup, and surface care.

FIG. 10 illustrates a flowchart of an example method 1000 for providing recommendations based on advanced attributes of basic elements of a project, in accordance with aspects of the present disclosure.

In step 1001, method 1000 creates a color project and groups. For example, method 200 may be used to create the color project. Then, method 1000 proceeds to step 1010.

In step 1010, method 1000 creates one or more new basic elements. The basic element may be, for example, a wall to be painted, a clothing part for fashion project, part of an industrial design project, etc.

In step 1020, method 1000 assigns a name to each of the one or more new basic elements created in step 1010.

In step 1030, method 1000 attaches metadata to each of the one or more new basic elements created in step 1010. For example, the metadata may comprise notes, images, data obtained from sensors, etc.

In step 1040, for each element of the one or more basic elements, method 1000 automatically assigns attributes based on the created project, the group, assigned name, metadata, etc. The method then proceeds to optional step 1050.

In optional step 1050, method 1000 presents the automatically assigned attributes to a user, and interactively receives one or more of: a confirmation of the assigned attributes, one or more modifications of the assigned attributes, and information missing from the assigned attributes.

In step 1060, for each basic element of the one or more basic elements, method 1000 provides a recommendation based on analysis of information associated with the respective basic element. For example, the information may include information used for assigning the attributes, information received from the user upon presentation of the automatically assigned attributed to the user. In other words, the information previously missing from the assigned attributes may be received from the user and used subsequently for the recommendation.

In one aspect, for the given element or group of elements, the selected paint/ink is applied. In one aspect, once the paint/ink is applied the method proceeds to comparison of the applied paint/ink to the target color (i.e., to the original target color). This step is performed to determine whether an adjustment is needed or whether the target color is achieved. As described above, based on the element on which the paint/ink is applied, previous layers of paint/ink that may have been applied, lighting, thickness of material, absorption properties, the comparison of the original target color with the applied paint/ink may indicate some differences and a need for further optimization. In which case, a measurement of closeness may be needed.

In one aspect, the comparison of the applied paint/ink to the target color may be performed using a compare function that shows how close the painted color is to the target color. In one aspect, the closeness may be quantified as a pass/fail function. In another aspect, the closeness may be quantified using a delta function that measures the color difference between the target color and the painted color. When the comparison results in a difference that is less than a predetermined difference, the applied paint color is considered as being a match to the target color. Otherwise, the applied paint color is considered as being a paint that does not match the target color. When the match is not found, further selection and optimization is performed, for example, by selecting a different paint from among the ones that were previously determined as having met the criteria. Alternatively, further measurements and optimization may be performed.

FIG. 11 illustrates a flowchart of an example method 1100 for managing a color project, in accordance with aspects of the present disclosure.

In step 1110, for each element or group of elements of the color project, method 1100 determines a target color. In one aspect, the target color for an element is selected by the user from a library. In another aspect, the target color is obtaining by making measurements of a sample.

In optional step 1120, for each element or group of elements, method 1100 provides to the user a selection of one or more potential matches from commercially available color systems using an advanced paint matching to a customer query algorithm via an application interface.

In optional step 1130, for each element or group of elements, method 1100 receives from the user a selection of a best match. In one aspect, the best match is determined based on predetermined criteria, for example, criteria based on accuracy of the match, availability of the paint, the price of the paint, and the like.

In step 1140, method 1100 applies paint on the element or group of elements. For example, a contractor or the user applies the paint for the project.

In step 1150, for each element or group of elements, method 1100 executes control measurements on color samples of applied paint.

In step 1160, for each element or group of elements, method 1100 analyzes a color difference between the color samples of the applied paint and the respective target color, and provides recommendation as to a need for a correction based the results of the analysis.

In step 1170, for each element or group of elements, method 1100 makes a correction to the selected best match when the recommendation indicates a need for the correction. Thus, using method 1100, the user manages the entire project in an automated manner by: determining the target color, identifying a match of a paint to the target color, and controlling the quality of the execution of the color project.

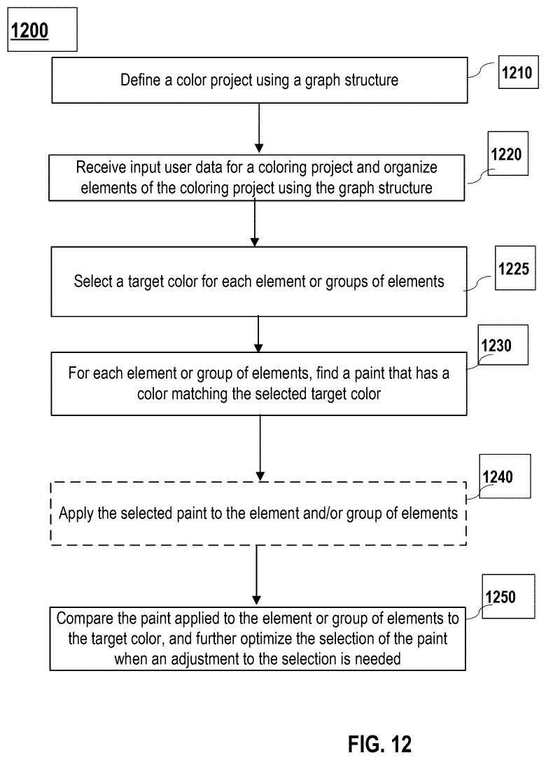

FIG. 12 illustrates a flowchart of an example method 1200 for automatically managing a coloring project in accordance with aspects of the present disclosure. The method 1200 may be implemented in a user device, for example, the device 110, as shown and discussed with regard to FIG. 1 above. For example, the application may be installed on an iPhone, iPad or similar device. In step 1210, method 1200 defines a coloring project using a graph structure.

In step 1220, method 1200 receives input user data for a coloring project and organizes elements of a coloring project using the graph structure.

In step 1225, method 1200 selects a target color for each element and/or group of elements.

In step 1230, for each element and/or group of elements, method 1200 finds a paint that has a color matching the selected target color.

In step 1240, method 1200 applies the selected paint to the element and/or group of elements.

In step 1250, method 1200 compares the paint applied to the element and/or group of elements with the target color, and further optimizes the selection of the paint when an adjustment to the selection is needed.

In one example aspect, the coloring project is managed via an automated management system, wherein the managing of the coloring project comprises, for each element or group of elements of the coloring project: determining the target color; applying a selected best match paint on the element or group of elements; executing control measurements on color samples of applied paint; analyzing a color difference between the color samples of the applied paint and the respective target color, and providing recommendation as to a need for a correction based results of the analysis; and correcting the selected best match paint when the recommendation indicates a need for the correction.

In one example aspect, the management of the coloring project further comprises, for each element or group of elements of the coloring project: providing to a user a selection of one or more potential matches from commercially available color systems using an advanced paint matching to a customer query algorithm via an application interface; and receiving a selection from the user, wherein the received selection comprises the selected best match paint.

In one example aspect, the paint that has a color matching the selected target color is automatically found by: storing a list of paint Stock Keeping Units (SKUs) in a database, wherein the list further includes information about each paint that has a paint SKU stored in the database; receiving a query from the user, wherein the query includes the target color; matching the target color to a paint color; searching in the database for at least one paint SKU associated with the matched paint color; selecting all paint SKUs associated with the matched paint color; determining availabilities of each of the selected paint SKUs; and creating a list of selected and available paint SKUs, and presenting the created list to the user for selecting, by the user, a preferred paint SKU form among paint SKUs on the list.

In one example aspect, the selecting of all paint SKUs associated with the matched paint color further comprises: querying for additional paint parameters in information associated with the coloring project; when the additional parameters are not described in the coloring project, receiving the additional paint parameters from the user in response to querying the user for the additional paint parameters; and selecting all paint SKUs associated with both the matched paint color and the additional paint parameters.

In one example aspect, the method further comprises: offering, to the user, options for ordering a selected paint online for a quantity needed for the painting project; when the offer is accepted by the user, placing an order for the selected paint, wherein a quantity of the paint needed for the coloring project is determined based on an area of a surface to be painted and a coverage of the paint having the selected paint SKU.

In one example aspect, the information about a paint that has a paint SKU stored in the database comprises one or more of: a unique identifier of the paint; a brand; a sub-brand or collection; manufacturer's SKU; color coordinates; color name; color number; Light Reflectance Value (LRV); color collection; finish or sheen; a type of paint indicative of whether the paint is an exterior paint or an interior paint; chemistry of the paint indicative of whether the paint is latex type or acrylic; container of the paint; base of the paint; types of surfaces on which the paint can be used; coverage of the paint; drying time of the paint; recommended number of coats of the paint; Volatile Organic Compound (VOC) content of the paint; features of the paint; and price of the paint.

In one example aspect, the selection of the target color comprises: receiving the input user data from the user via an AI based chat application, the input data comprising at least one of: a textual description of a color of paint, color coordinates obtained using a colorimeter or a digital camera, or color coordinates of digital color data from a photograph; presenting to the user, via the AI based chat application, a selected patch representative of a paint matching the input user data; interacting with the user, via the AI based chat application, to adjust the selection of the patch when an adjustment is requested by the user; and when confirmation is received from the user indicating that the presented patch matches the input user data, selecting the paint represented by the patch as the target color.

In one example aspect, the method further comprises: interacting with the user via the AI based chat application and receiving a context for the coloring project; and generating names for colors that are obtained from the input user data based on the context of the coloring project.

In one example aspect, the input user data is obtained by at least one of the following: physically scanning colors using a colorimeter, or a spectrophotometer communicatively coupled to a device of the user; extracting colors from one or more digital images; entering color data in a standard format by the user; selecting color from a library of colors; and picking a color from among previously stored color data, for instance from the same or another project.

In one example aspect, for each element or group of elements, the finding of the respective paint that has a color matching the selected target color of the element or group of elements comprises: when a match between the target color and at least one paint color in a database is found, selecting the respective paint from among paints that meet a threshold criterion based on a distance between the target color and particular paints that meet the threshold criterion; when no match between the target color and at least one color in the database is found, determining whether a custom color can be created within the color library; when no match between the target color and at least one color in the color library is found and the custom color can be created within the color library, recommending a custom paint based on a respective color Gamut of a matched paint color; and when no match between the target color and at least one color in the color library is found and the custom color cannot be created within the color library, recommending an inspired paint color.

In one example aspect, the determination of whether the custom color can be created within a color library is based on color coordinates of the target color being within a color Gamut of at least one paint brand in the color library.

In one example aspect, the determination of whether the custom color can be created within the color library comprises: for each paint or paint brand of a coloring system, modeling color Gamuts of the color library to describe respective entire ranges of each color and tone achievable by the coloring system, wherein the modeling of the color Gamut is based on color measurements of commercially available color samples of a color system; mapping measured color coordinates of the measured color samples on a 3-dimensional color space; and creating a model of the color Gamut of the color system based on the color samples farthest from a center of the 3-dimensional color space.

In one example aspect, the graph structure is a tree structure that allows the user to: organize elements of a coloring project hierarchically; store color data and metadata in elements of the coloring project; assign custom names and naming systems to elements or groups of elements of the coloring project; navigate the structure using collapsible branches; evaluate projects by scrolling through the entire tree structure or by focusing on different branches of the tree structure; search for elements and groups of elements using search filters; group and regroup elements into branches according to current needs of the user for the coloring project; and assign status to elements or groups of elements, where the status includes at least one of: priority, current progress, assignment of a person responsible for a project or for an element.

FIG. 13 is a block diagram illustrating various components of an example computer system 20 via which aspects of the present disclosure for managing a coloring project may be implemented. The computer system 20 may, for example, be or include a computing system of the user device, or may comprise a separate computing device communicatively coupled to the user device, etc. In addition, the computer system 20 may be in the form of multiple computing devices, or in the form of a single computing device, including, for example, a mobile computing device, a cellular telephone, a smart phone, a desktop computer, a notebook computer, a laptop computer, a tablet computer, a server, a mainframe, an embedded device, and other forms of computing devices.

As shown in FIG. 13, the computer system 20 may include one or more central processing units (CPUs) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I2C, and other suitable interconnects. The central processing unit 21 (also referred to as a processor) may include a single or multiple sets of processors having single or multiple cores. The processor 21 may execute one or more computer-executable lines of code implementing techniques in accordance with aspects of the present disclosure. The system memory 22 may be or include any memory for storing data used herein and/or computer programs that are executable via the processor 21. The system memory 22 may include volatile memory, such as a random access memory (RAM) 25 and non-volatile memory, such as a read only memory (ROM) 24, flash memory, etc., or any combination thereof. The basic input/output system (BIOS) 26 may store the basic procedures for transfer of information among elements of the computer system 20, such as those at the time of loading the operating system with the use of the ROM 24.

The computer system 20 may include one or more storage devices, such as one or more removable storage devices 27, one or more non-removable storage devices 28, or a combination thereof. The one or more removable storage devices 27 and non-removable storage devices 28 may be coupled to the system bus 23 via a storage interface 32. In an aspect, the storage devices and the corresponding computer-readable storage media may be or include power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory, such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology, such as in solid state drives (SSDs) or flash drives; magnetic cassettes, magnetic tape, and magnetic disk storage, such as in hard disk drives or floppy disks; optical storage, such as in compact disks (CD-ROM) or digital versatile disks (DVDs); and any other medium that may be used to store the desired data and that may be accessed via the computer system 20.

The system memory 22, removable storage devices 27, and/or non-removable storage devices 28 of the computer system 20 may be used to store an operating system 35, additional program applications 37, other program modules 38, and/or program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47, such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

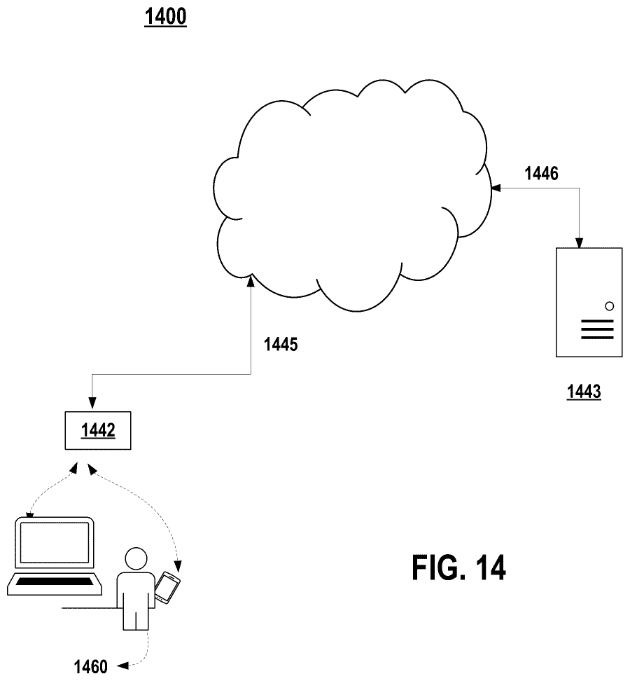

The computer system 20 may operate in a network environment as shown in FIG. 14, using a network connection to one or more remote computers 49. The remote computer (or computers) 49 may be or include local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks, such as a local-area computer network (LAN) 50, a wide-area computer network (WAN), an intranet, and the Internet. Examples of the network interface 51 may include an Ethernet interface, a Frame Relay interface, SONET interface, and wireless interfaces.

FIG. 14 is a block diagram of various example system components, usable in accordance with aspects of the present disclosure. FIG. 14 shows a communication system 1400 usable in accordance with aspects of the present disclosure. The communication system 1400 includes one or more accessors 1460 (also referred to interchangeably herein as one or more “users”) and one or more terminals 1442. In one aspect, data for use in accordance with aspects of the present disclosure may, for example, be input and/or accessed by accessors 1460 via terminals 1442, such as personal computers (PCs), minicomputers, mainframe computers, microcomputers, telephonic devices, or wireless devices, such as personal digital assistants (“PDAs”), smart phones, or other hand-held wireless devices coupled to a server 1443, such as a PC, minicomputer, mainframe computer, microcomputer, or other device having a processor and a repository for data and/or connection to a repository for data, via, for example, a network 1444, such as the Internet or an intranet, and couplings 1445, 1446. In one aspect, various features of the method may be performed in accordance with a command received from another device via a coupling 1445, 1446. The couplings 1445, 1446 may include, for example, wired, wireless, or fiberoptic links. In another variation, various features of the method and system in accordance with aspects of the present disclosure may operate in a stand-alone environment, such as on a single terminal. In one aspect, the server 1443 may be a remote computer 49, as shown in FIG. 13, or a local server.

Aspects of the present disclosure may be or include a system, a method, and/or a computer program product. The computer program product may include any number and type of computer readable storage medium (or media) having computer readable program instructions thereon for causing one or more processors to carry out aspects of the present disclosure.

The computer readable storage medium may be or include a tangible device that may retain and store program code in the form of instructions or data structures that may be accessed via a processor of one or more processors of any number of computing devices, such as the computing system 20. The computer readable storage medium may be or include an electronic storage device, a magnetic storage device, an optical storage device, an electromagnetic storage device, a semiconductor storage device, or any suitable combination thereof. By way of example, such computer-readable storage medium may comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device, such as punch-cards or raised structures in a groove having instructions recorded thereon. As used herein, a computer readable storage medium is not to be construed as being or only being transitory signals per se, such as radio waves or other freely propagating electromagnetic waves, electromagnetic waves propagating through a waveguide or transmission media, or electrical signals transmitted through a wire.

Computer readable program instructions described herein may be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations in accordance with aspects of the present disclosure may be or include assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be coupled to the user's computer via any suitable type of network, including a LAN or WAN, or the connection may be made to an external computer (for example, through the Internet). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform various functions in accordance with aspects of the present disclosure.

In various aspects, the systems and methods described in the present disclosure may be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system (such as the one described in greater detail in FIG. 13, above). Accordingly, each module may be realized in a variety of suitable configurations, and should not be limited to any particular implementation shown or described as an example herein.

In the interest of clarity, not all of the routine features of the aspects are disclosed herein. It will be appreciated that in the development of any actual implementation of features in accordance with aspects of the present disclosure, numerous implementation-specific decisions may be made in order to achieve the developer's specific goals, and these specific goals may vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of various features in accordance with aspects of the present specification are to be interpreted by one of ordinary skill in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it will be apparent to those skilled in the art having the benefit of this disclosure that many more modifications than mentioned above are possible without departing from the innovative concepts disclosed herein.

1. A method for matching color using a graph structure, the method comprising:
defining a coloring project using the graph structure;
receiving, from a user, input user data for the coloring project;
organizing elements of the coloring project using the graph structure;
selecting a target color for each element or group of elements of the coloring project;
for each element or group of elements, finding a respective paint that has a color matching the selected target color of the element or group of elements;
after the selected paint is applied to the element or group of elements, comparing the paint applied to the element or group of elements with the respective target color; and
making an adjustment to the selection of the paint when further optimization of the selection of the paint is needed based on the comparison of the paint applied to the element or group of elements with the respective target color.

2. The method of claim 1, wherein the coloring project is managed via an automated management system, wherein the managing of the coloring project comprises, for each element or group of elements of the coloring project:
determining the target color;
applying a selected best match paint on the element or group of elements;
executing control measurements on color samples of applied paint;
analyzing a color difference between the color samples of the applied paint and the respective target color, and providing recommendation as to a need for a correction based results of the analysis; and
correcting the selected best match paint when the recommendation indicates a need for the correction.

3. The method of claim 2, wherein the management of the coloring project further comprises, for each element or group of elements of the coloring project:
providing to a user a selection of one or more potential matches from commercially available color systems using an advanced paint matching to a customer query algorithm via an application interface; and
receiving a selection from the user, wherein the received selection comprises the selected best match paint.

4. The method of claim 1, wherein the paint that has a color matching the selected target color is automatically found by:
storing a list of paint Stock Keeping Units (SKUs) in a database, wherein the list further includes information about each paint that has a paint SKU stored in the database;
receiving a query from the user, wherein the query includes the target color;
matching the target color to a paint color;
searching in the database for at least one paint SKU associated with the matched paint color;
selecting all paint SKUs associated with the matched paint color;
determining availabilities of each of the selected paint SKUs; and
creating a list of selected and available paint SKUs, and presenting the created list to the user for selecting, by the user, a preferred paint SKU form among paint SKUs on the list.

5. The method of claim 4, wherein the selecting of all paint SKUs associated with the matched paint color further comprises:
querying for additional paint parameters in information associated with the coloring project;
when the additional parameters are not described in the coloring project, receiving the additional paint parameters from the user in response to querying the user for the additional paint parameters; and
selecting all paint SKUs associated with both the matched paint color and the additional paint parameters.

6. The method of claim 4, further comprising:
offering, to the user, options for ordering a selected paint online for a quantity needed for the painting project;
when the offer is accepted by the user, placing an order for the selected paint, wherein a quantity of the paint needed for the coloring project is determined based on an area of a surface to be painted and a coverage of the paint having the selected paint SKU.

7. The method of claim 4, wherein information about a paint that has a paint SKU stored in the database comprises one or more of:
a unique identifier of the paint;
a brand;
a sub-brand or collection;
a manufacturer SKU corresponding to the paint SKU, if applicable;
a color coordinate;
a color name;
a color number;
a Light Reflectance Value (LRV);
a color collection;
a finish or sheen;
a type of paint indicative of whether the paint is an exterior paint or an interior paint;
a chemistry of the paint indicative of whether the paint is latex type or acrylic;
a container of the paint;
a base of the paint;
a type of surface on which the paint can be used;
coverage of the paint;
drying time of the paint;
a recommended number of coats of the paint;
a Volatile Organic Compound (VOC) content of the paint;
a feature of the paint; and
a price of the paint.

8. The method of claim 1, wherein the selection of the target color comprises:
receiving the input user data from the user via an AI based chat application, the input data comprising at least one of: a textual description of a color of paint, color coordinates obtained using a colorimeter or a digital camera, or color coordinates of digital color data from a photograph;
presenting to the user, via the AI based chat application, a selected patch representative of a paint matching the input user data;
interacting with the user, via the AI based chat application, to adjust the selection of the patch when an adjustment is requested by the user; and
when confirmation is received from the user indicating that the presented patch matches the input user data, selecting the paint represented by the patch as the target color.

9. The method of claim 1, further comprising,
interacting with the user via an AI based chat application and receiving a context for the coloring project; and
generating names for colors that are obtained from the input user data based on the context of the coloring project.

10. The method of claim 1, wherein the input user data is obtained by at least one of:
physically scanning colors using a colorimeter or a spectrophotometer communicatively coupled to a device of the user;
extracting colors from one or more digital images;
manually entering color data in a standard format by the user;
selecting color from a library of colors; and
picking a color from among previously stored color data.

11. The method of claim 1, wherein, for each element or group of elements, the finding of the respective paint that has a color matching the selected target color of the element or group of elements comprises:
when a match between the target color and at least one paint color in a database is found, selecting the respective paint from among paints that meet a threshold criterion based on a distance between the target color and particular paints that meet the threshold criterion;
when no match between the target color and at least one color in the database is found, determining whether a custom color can be created within a color library;
when no match between the target color and at least one color in the color library is found and the custom color can be created within the color library, recommending a custom paint based on a respective color Gamut of a matched paint color; and
when no match between the target color and at least one color in the color library is found and the custom color cannot be created within the color library, recommending an inspired paint color.

12. The method of claim 11, wherein the determination of whether the custom color can be created within a color library is based on color coordinates of the target color being within a color Gamut of at least one paint brand in the color library.

13. The method of claim 11, wherein the determination of whether the custom color can be created within the color library comprises:
for each paint or paint brand of a coloring system, modeling color Gamuts of the color library to describe respective entire ranges of each color and tone achievable by the coloring system, wherein the modeling of the color Gamut is based on color measurements of commercially available color samples of a color system;
mapping measured color coordinates of the measured color samples on a 3-dimensional color space; and
creating a model of the color Gamut of the color system based on the color samples farthest from a center of the 3-dimensional color space.

14. The method of claim 1, wherein the graph structure is a tree structure that allows the user to:
organize elements of a coloring project hierarchically;
store color data and metadata in elements of the coloring project;
assign custom names and naming systems to elements or groups of elements of the coloring project;
navigate the structure using collapsible branches;
evaluate projects by scrolling through an entire tree structure or by focusing on different branches of the tree structure;
search for elements and groups of elements using search filters;
group and regroup elements into branches according to current needs of the user for the coloring project; and
assign status to elements or groups of elements, where the status includes at least one of: priority, current progress, assignment of a person responsible for a project or for an element.

15. A system for managing color matching comprising:
at least one memory; and
at least one processor coupled with the at least one memory and configured, individually or in combination with the at least one memory, to:
define a coloring project using a graph structure;
receive, from a user, input user data for the coloring project;
organize elements of the coloring project using the graph structure;
select a target color for each element or group of elements of the coloring project;
for each element or group of elements, find a respective paint that has a color matching the selected target color of the element or group of elements;
after the selected paint is applied to the element or group of elements, compare the paint applied to the element or group of elements with the respective target color; and
make an adjustment to the selection of the paint when further optimization of the selection of the paint is needed based on the comparison of the paint applied to the element or group of elements with the respective target color.

16. The system of claim 15, wherein the coloring project is managed via an automated management system, wherein the managing of the coloring project comprises, for each element or group of elements of the coloring project:
determining the target color;
applying a selected best match paint on the element or group of elements;
executing control measurements on color samples of applied paint;
analyzing a color difference between the color samples of the applied paint and the respective target color, and providing recommendation as to a need for a correction based results of the analysis; and
correcting the selected best match paint when the recommendation indicates a need for the correction.

17. The system of claim 15, wherein the paint that has a color matching the selected target color is automatically found by:
storing a list of paint Stock Keeping Units (SKUs) in a database, wherein the list further includes information about each paint that has a paint SKU stored in the database;
receiving a query from the user, wherein the query includes the target color;
matching the target color to a paint color;
searching in the database for at least one paint SKU associated with the matched paint color;
selecting all paint SKUs associated with the matched paint color;
determining availabilities of each of the selected paint SKUs; and
creating a list of selected and available paint SKUs, and presenting the created list to the user for selecting, by the user, a preferred paint SKU form among paint SKUs on the list.

18. A non-transitory computer readable medium storing thereon computer executable instructions for managing color matching for a project of a customer, including instructions for:
defining a coloring project using a graph structure;
receiving, from a user, input user data for the coloring project;
organizing elements of the coloring project using the graph structure;
selecting a target color for each element or group of elements of the coloring project;
for each element or group of elements, finding a respective paint that has a color matching the selected target color of the element or group of elements;
after the selected paint is applied to the element or group of elements, comparing the paint applied to the element or group of elements with the respective target color; and
making an adjustment to the selection of the paint when further optimization of the selection of the paint is needed based on the comparison of the paint applied to the element or group of elements with the respective target color.

19. The non-transitory computer readable medium of claim 18, wherein the coloring project is managed via an automated management system, wherein instructions for managing of the coloring project comprise instructions for performing for each element or group of elements of the coloring project:
determining the target color;
applying a selected best match paint on the element or group of elements;
executing control measurements on color samples of applied paint;
performing analysis of a color difference between the color samples of the applied paint and the respective target color, and providing recommendation as to a need for a correction based results of the analysis; and
correcting the selected best match paint when the recommendation indicates a need for the correction.

20. The non-transitory computer readable medium of claim 18, wherein the paint that has a color matching the selected target color is automatically found by:
storing a list of paint Stock Keeping Units (SKUs) in a database, wherein the list further includes information about each paint that has a paint SKU stored in the database;
receiving a query from the user, wherein the query includes the target color;
matching the target color to a paint color;
searching in the database for at least one paint SKU associated with the matched paint color;
selecting all paint SKUs associated with the matched paint color;
determining availabilities of each of the selected paint SKUs; and
creating a list of selected and available paint SKUs, and presenting the created list to the user for selecting, by the user, a preferred paint SKU form among paint SKUs on the list.
